(19) United States
(12) Patent Application Publication
(10) Pub. No.: US 2026/0270296 A1
(43) Pub. Date: Sep. 10, 2026

(54) REAL-TIME AI/ML SOCIAL ENGINEERING ATTACK DETECTION SYSTEM

(71) Applicant: International Business Machines Corporation, Armonk, NY (US)

(72) Inventors: Isaac ZAVALA, Round Rock, TX (US); John B. CARTER, Austin, TX (US); Ophilia LIMA, Austin, TX (US)

(21) Appl. No.: 19/070,518

(22) Filed: Mar. 4, 2025

(51) Int. Cl. H04L 9/40; G10L 25/51

(52) U.S. Cl. CPC H04L 63/1483; G10L 25/51; H04L 63/1433

(57) ABSTRACT

In some implementations, a computing device may train a real-time AI cybersecurity model using historical data associated with a user, comprising audio data, video data, image data, communication patterns, social media information, and/or contact information; provide communication channel data associated with a plurality of devices with which the user is associated to the real-time AI cybersecurity model; receive an output from the real-time AI cybersecurity model that includes (i) detection of AI-generated content in the communication channel data, (ii) an anomalous score associated with the communication channel data, (iii) a threat pattern associated with the communication channel data, (iv) a tone analysis associated with the communication channel data, and/or (v) a risk analysis associated with at the communication channel data; and display, on one of the plurality of devices, an alert to the user regarding potential malicious behavior in the communication channel data.

### BACKGROUND

Frequently, scammers assume false identities as friends, family members, or representatives from reputable entities like banks, government agencies, or tech support firms. Scammers can employ a range of tactics to trick victims into divulging personal information, funds, or access to their devices. Common phone scams encompass “social engineering” schemes such as impostors posing as government agents or law enforcement agencies, fraudulent technical support, deceptive lottery offers, or the like.

### SUMMARY

In some implementations, a method comprises training a real-time AI cybersecurity model using historical data associated with a user, wherein the historical data comprises audio data, image data, social media postings, video data, communication patterns, and/or contact information; providing communication channel data associated with a plurality of devices with which the user is associated to the real-time AI cybersecurity model, wherein the communication channel data comprises audio data, video data, text data, social media post data, and/or image data from the plurality of devices; receiving an output from the real-time AI cybersecurity model that includes (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, and/or (v) a risk analysis associated with at least one component of the communication channel data; and providing, on one of the plurality of devices, an alert to the user regarding potential malicious behavior in the communication channel data.

In some implementations, a computer program product comprises: one or more computer readable storage media, and program instructions collectively stored on the one or more computer readable storage media. The computer program product includes instructions comprising program instructions to train a real-time AI cybersecurity model using historical data associated with a user, wherein the historical data comprises audio data, image data, social media postings, video data, communication patterns, and/or contact information; providing communication channel data associated with a plurality of devices with which the user is associated to the real-time AI cybersecurity model, wherein the communication channel data comprises audio data, video data, text data, and/or image data from the plurality of devices; receive an output from the real-time AI cybersecurity model that includes (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, and/or (v) a risk analysis associated with at least one component of the communication channel data; and provide, on one of the plurality of devices, an alert to the user regarding potential malicious behavior in the communication channel data.

In some implementations, a system comprises one or more devices configured to train a real-time AI cybersecurity model using historical data associated with a user, wherein the historical data comprises audio data, video data, communication patterns, and/or contact information; provide communication channel data associated with a plurality of devices with which the user is associated to the real-time AI cybersecurity model, wherein the communication channel data comprises audio data, video data, text data, and/or image data from the plurality of devices; receive an output from the real-time AI cybersecurity model that includes (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, and/or (v) a risk analysis associated with at least one component of the communication channel data; and provide, on one of the plurality of devices, an alert to the user regarding potential malicious behavior in the communication channel data.

### BRIEF DESCRIPTION OF THE DRAWINGS

FIGS. 1-12 are diagrams of an example implementation described herein.

FIG. 13 is a diagram of an example computing environment in which systems and/or methods described herein may be implemented.

FIG. 14 is a diagram of example components of one or more devices of FIGS. 1-10.

FIG. 15 is a flowchart of an example process for detecting potential threats associated with one or more communication channels using the techniques described herein.

### DETAILED DESCRIPTION

The following detailed description of example implementations refers to the accompanying drawings. The same reference numbers in different drawings may identify the same or similar elements.

Social engineering attacks may be employed by scammers or other malicious agents in order to gain access to sensitive information such as banking information or passwords, elicit fraudulent payments, or to perform other malicious activities. Embodiments described herein include an artificial intelligence/machine learning (AI/ML) social engineering detection system that can identify, and help to avoid, scams such as social engineering attacks in real time or near-real time. As discussed below, the AI/ML social engineering detection system may monitor content in voice, text message, social media content, or other suitable information in real-time, and may quickly and reliably detect when a scam such as a social engineering attack is occurring. As discussed below, the AI/ML social engineering detection system may further alert a user of such a social engineering attack, in order to aid in avoiding falling victim to such attack. As further discussed below, the AI/ML social engineering detection system may analyze different modes of communication associated with multiple users, in order to provide personalized alerts of possible scams that are tailored to specific attributes or patterns associated with particular respective users.

In an example use case, the AI/ML social engineering detection system may be integrated into security endpoint solutions in order to address “spearfishing,” social engineering attacks, or other types of malicious activities. As another example, the AI/ML social engineering detection system may be integrated into internal tools or devices of a company or organization (e.g., email tools, videoconferencing tools, Voice over IP (VoIP) tools, company-issued smartphones, or the like) in order reduce cyber attack exposure for the company or organization. In another example, the AI/ML social engineering detection system may be integrated in or licensed for end-user consumer products, such as smartphones, smart home assistants, email clients, or the like. In one example, the AI/ML social engineering detection system may be offered as a service (e.g., a free or “freemium” service).

In some embodiments, the AI/ML social engineering detection system includes a multi-modal system that is able to warn users of potential scams such as social engineering attacks. The system may be multi-modal inasmuch as multiple modes of communication may be analyzed in real time or near-real time, both in the detection of potential scams as well as the training or generation of personalized AI/ML models that may be used to detect potential scams for a given user. As discussed below, the AI/ML social engineering detection system may, for example, analyze speech patterns, language, audio cues, and/or other potential signals in order to identify potential scams, such as social engineering attacks.

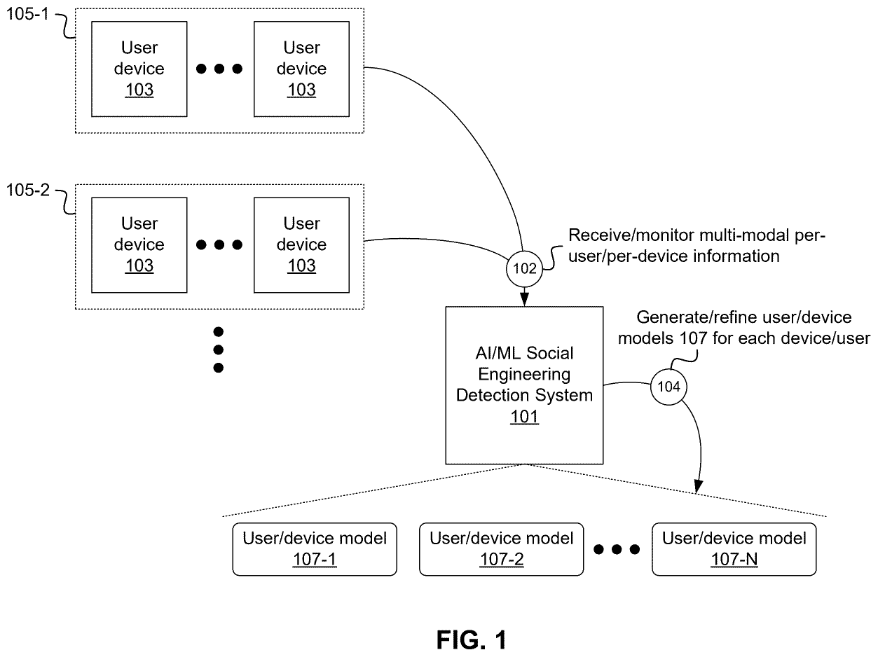

As shown in FIG. 1, AI/ML Social Engineering Detection System (ASEDS) 101 may receive or monitor (at 102) monitor multi-modal per-user and/or per-device information associated with one or more user devices 103. User devices 103 may include, for example, smartphones, laptops, Internet of Things (IoT) devices, smart home devices, or other suitable types of devices. In one example, different user devices 103 may be organized or categorized as belonging to particular device groups 105, such as example device groups 105-1 and 105-2. In one example, device group 105-1 is associated with a first user or a first set of users (e.g., a particular individual, a particular family, a particular company or organization, etc.), and device group 105-2 is associated with a second user or a second set of users. As another example, device group 105-1 is associated with a first device type (e.g., smartphones, IoT devices, smart home devices, etc.), and device group 105-2 is associated with a second device type. In some embodiments, device groups 105 may be organized in some other suitable manner.

Receiving (at 102) multi-modal per-user and/or per-device information may include receiving or monitoring communications or traffic sent to or received from one or more user devices 103, such as voice call traffic, videoconferencing traffic, file download traffic, content streaming traffic, or the like. In some embodiments, the multi-modal information may include information extracted from or included in linked accounts or information associated with a given user device 103 or user, such as social media accounts, forum posts, or the like. In some embodiments, the multi-modal information may include contact information, such as based on address book information, contact list information, call history information, and/or other suitable information maintained or provided by one or more user devices 103. In some embodiments, the multi-modal information (received at 102) may include any other suitable type of information associated with particular user devices 103 and/or users thereof.

ASEDS 101 may generate and/or refine (at 104) one or more cybersecurity models, such as user/device models 107 (e.g., user and/or device models 107-1, 107-2, 107-N, etc.), based on the received multi-modal per-user and/or per-device information. As discussed below, user and/or device models 107 may be real-time models that are modified or refined in real-time. In some embodiments, ASEDS 101 may utilize AI/ML modeling techniques, such as neural networks, K-means clustering, labeling, and/or other suitable modeling techniques, to generate, refine, train, etc. user and/or device models 107. In this manner, each respective device group 105 (as maintained by ASEDS 101) may reflect history information, profile information, and/or other suitable information associated with a particular user, a particular user device 103, a particular device group 105, or the like. As discussed below, ASEDS 101 may utilize user and/or device models 107 to identify potential threats such as scams, social engineering attacks, etc. directed to particular users, user devices 103, or device groups 105, in a manner that is tailored to the specifics of such users, user devices 103, or device groups 105, thus enhancing the accuracy and reliability of the threat detection, while potentially reducing the quantity of “false positives” of detected threats.

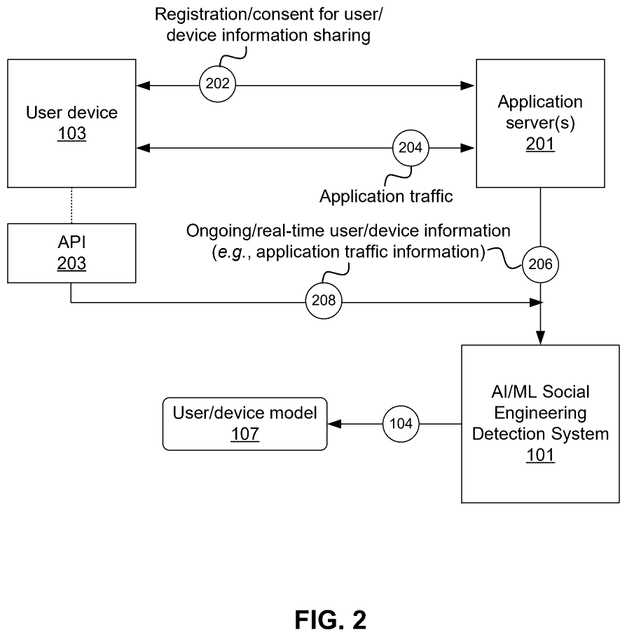

FIG. 2 illustrates an example implementation of generating or refining a particular user and/or device model 107 for a particular user device 103. As discussed above, similar concepts may apply for a particular device group 105 that includes multiple user devices 103. As shown, user device 103 may be registered (at 202) with one or more application servers 201, which may include devices or systems that provide network-based services to user device 103, such as voice call services, videoconferencing services, banking services, content streaming services, gaming services, and/or other types of services. For example, user device 103 may execute a “client side” application associated with a service provided by application server 201, and application server 201 may execute a “server side” application associated with the service. As part of the registration, user device 103 may indicate permission or consent (e.g., as provided by a user of user device 103) for application server 201 to forward information associated with user device 103 to ASEDS 101. For example, application server 201 may instruct user device 103 to present a graphical user interface (GUI) that requests consent to provide such information to ASEDS 101, and a user may provide the consent via the GUI. The information associated with user device 103, for which the user may provide the consent, may include one or more identifiers of user device 103 and/or the user of user device 103, information associated with services provided to user device 103, traffic sent to or received from user device 103, descriptions of services provided to user device 103, and/or other suitable information.

In the course of providing services to application server 201, user device 103 may send and/or receive (at 204) application traffic to each other. In one example, the application traffic may include audio information, such as voice call information. The voice call information may be associated with a voice call session between user device 103 and another device (e.g., another user device 103), where such voice call session is facilitated by, implemented by, or otherwise associated with application server 201. The voice call information may include, for example, a voice of a user of user device 103, a voice of a user of the other device associated with the voice call session, etc.

In another example, the application traffic may include visual or text-based messaging information. The visual or text-based messaging information may include, for example, content of text messages or other written communications between user device 103, application server 201, and/or one or more other devices or systems. The visual or text-based messaging information may include, as another example, one or more pictures or videos sent to or from user device 103.

In some embodiments, application server 201 may perform a filtering or extraction process to identify information to send to ASEDS 101. For example, application server 201 may send some, but not all, application traffic to ASEDS 101. In a scenario where the application traffic includes voice call traffic, application server 201 may receive a username or device identifier from user device 103, and may send contents of some of the voice call traffic to ASEDS 101 without providing the username or device identifier to ASEDS 101. As anther example, application server 201 may identify certain portions of application traffic to send to ASEDS 101, such as text, audio files, video files, image files, etc. that are embedded in or are attached to communications to or from user device 103, such as emails, text messages, or the like. Application server 201 may provide (at 206) the application traffic or a subset thereof (e.g., user and/or device information associated with user device 103) to ASEDS 101 to ASEDS 101 on ongoing and/or real time basis. In this manner, ASEDS 101 may effectively monitor application traffic associated with user device 103, including voice communications, image-based communications, video-based communications, etc., subject to consent of the user of user device 103.

In some embodiments, in addition to or in lieu of authorizing one or more application servers 201 to send ongoing user and/or device information to ASEDS 101, user device 103 may implement application programming interface (API) 203, via which user device 103 may communicate with ASEDS 101. In some embodiments, API 203 may communicate with (e.g., provide an interface to) one or more applications executing at user device 103, an operating system of user device 103, or the like. For example, API 203 may receive application traffic from one or more applications executing at user device 103 (e.g., voice call applications, videoconferencing applications, social media applications, web browsing applications, or the like). In some embodiments, a given application executing at user device 103 may communicate (at 204) with application server 201, and may simultaneously or concurrently provide some or all of the application traffic to API 203. API 203 may be configured to output (at 208) user and/or device information (e.g., including or based on application traffic output by one or more applications executing at user device 103) to application server 201 on an ongoing real time basis, as similarly discussed above.

In some embodiments, ASEDS 101 may receive user and/or device information, associated with user device 103 or a user thereof, from one or more other sources. For example, ASEDS 101 may “crawl” social media sites to identify social contacts or other information associated with the user of user device 103. As another example, ASEDS 101 may receive information regarding user device 103 or a user thereof from a network carrier with which user device 103 is registered or provisioned. As another example, ASEDS 101 may receive regarding user device 103 or a user thereof from a public records database or some other suitable source. As another example, ASEDS 101 may receive information regarding user device 103 or a user thereof from a secure interface with a governmental agency or other private database.

As discussed above, ASEDS 101 may generate or refine (at 104) a respective user and/or device model 107 for user device 103 or the user thereof, based on application traffic (associated with one or more services received by user device 103) between user device 103 and one or more application servers 201, and/or further based on other suitable user or device information received over time, in order to continuously and on an ongoing basis refine user and/or device model 107 to more accurately reflect historical trends, tendencies, preferences, configurations, and/or other attributes of user device 103 and/or the user thereof. In one embodiment, user and/or device model 107 may identify a set of contacts (e.g., first-degree contacts such as close friends or relatives, second-degree contacts such as friends of friends, etc.) with which user device 103 or the user is associated. In one embodiment, user and/or device model 107 may include or may be based on a call or communication history between user device 103 and one or more respective users or devices. User and/or device model 107 may include historical information such as dates and/or times at which a particular user or user device 103 sends or receives voice calls, participates in videoconferences, sends or receives text messages, etc. In one embodiment, user and/or device model 107 may include or represent audio or video content associated with user device 103 or the user, such as voice samples, images or videos of the user's face, etc.

In some embodiments, user and/or device model 107 may include information indicating modes of communication between user device 103 and one or more other users or devices. For example, user and/or device model 107 may indicate that user device 103 typically communicates with a first contact via voice call, and that user device 103 typically communicates with a first contact via text-based messaging.

In some embodiments, user and/or device model 107 may include content-based historical information associated with one or more contacts of user device 103 (e.g., contact with which user device 103 has communicated in the past). The content-based historical information may include, for example, words or phrases spoken or written between user device 103 and the contact, voice samples of the contact, and/or other suitable information.

In some embodiments, user and/or device model 107 may include location information or location history information. For example, user device 103 may report its location to ASEDS 101, ASEDS 101 may receive location information of user device 103 from a wireless network with which user device 103 is registered (e.g., with user consent), and/or from some other suitable source.

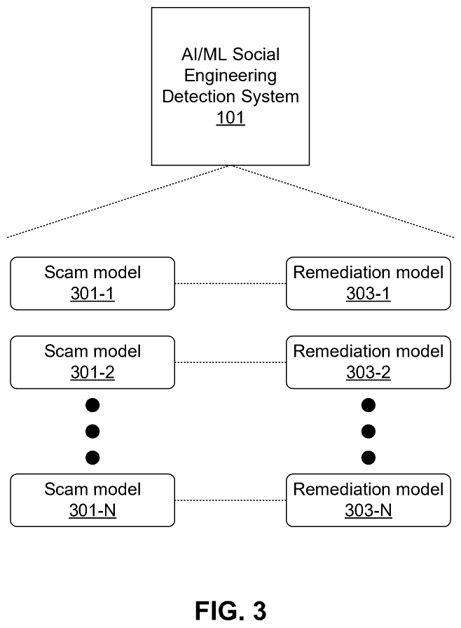

Turning to FIG. 3, ASEDS 101 may additionally generate, refine, receive, and/or otherwise maintain one or more scam models 301 (e.g., scam models 301-1, 301-2, 301-N, etc.). Scam models 301 may include information based on which scams such as social engineering attacks may be identified. Such information may include, for example, telephone numbers commonly reported as scam or spam, content of voice calls identified as being associated with scams (e.g., voice calls containing certain words or phrases commonly associated with scams) or social engineering attacks, or other suitable information based on which a social engineering attack or other type of scam may be identified.

In another example, scam models 301 may include geographical location information of callers or other individuals that have been identified as being associated with scams (e.g., locations from which scam calls or other types of communications have been sent). Scam models 301 may indicate modes of communication of respective scam communications, such as whether particular scam communication or type of scam communication has been made via voice call, video call, text message, social media, email, etc. Scam models 301 may indicate personal relationships with which certain scams are associated (e.g., a “Your son is in jail” communication may be associated with a parent-son relationship). Scam models 301 may indicate requested actions or categories (e.g., as indicated in content of respective scam communications), such as “Send money,” “Reveal password,” “Install software,” etc. Scam models 301 may indicate certain scripts, files, or executable programs that have been identified as being associated with scams. Scam models 301 may, in some embodiments, include additional or different information based on which scams, social engineering attacks, or the like, may be identified.

Remediation models 303 may indicate one or more actions to perform when a respective scam model 301 is identified. For example, scam model 301-1 may be associated with a first remediation model 303-1, scam model 301-2 may be associated with a second remediation model 303-2, scam model 301-N may be associated with a third remediation model 303-N, and so on. Different remediation actions may be appropriate in different situations. For example, in a first scenario (e.g., associated with scam model 301-1), remediation model 303-1 may indicate an action such as playing an audible warning that a potential threat has been identified. As another example, in a second scenario (e.g., associated with scam model 301-2), remediation model 303-2 may indicate an action such as immediately and automatically ending a voice call, such as in a situation where the identified scam has a high likelihood of success or some other high measure of risk or harm.

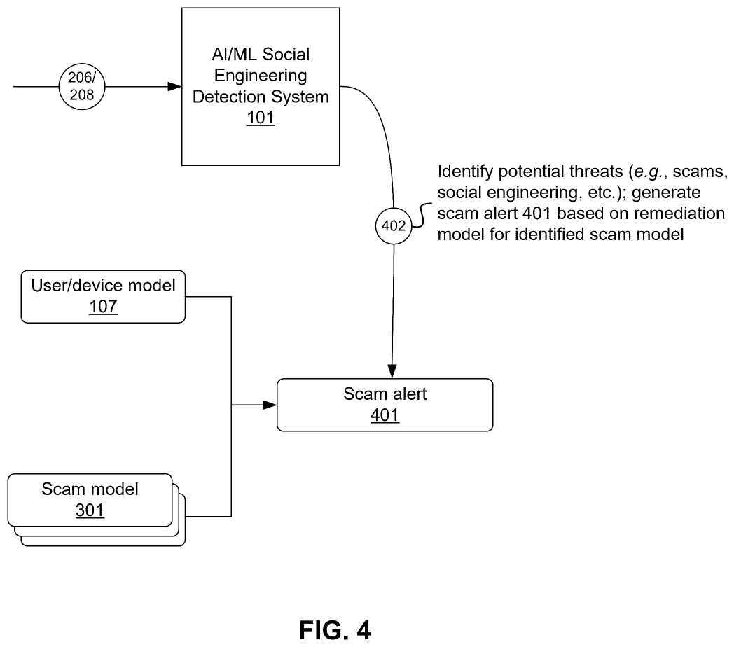

As shown in FIG. 4, ASEDS 101 may use user and/or device model 107, for a particular user or user device 103, as well as one or more scam models 301, to identify potential threats (e.g., scams, social engineering attacks, etc.) associated with communications sent to or received by user device 103. As noted above, since this detection of potential threats is based on particular attributes of the user or user device 103 (e.g., as indicated by user and/or device model 107), the detection of such threats may be more accurate, reliable, and personalized than techniques that do not leverage attributes of the user or user device 103.

As discussed above, ASEDS 101 may receive (e.g., at 206 or 208) user and/or device information associated with user device 103, such as real time voice communications, video communications, text-based communications, emails, or the like. In this sense, ASEDS 101 may monitor application traffic or other communications sent to or received by user device 103 in real time or near-real time. In situations, where ASEDS 101 detects or identifies (at 402) a potential threat such as a scam, a social engineering attack, etc. ASEDS 101 may perform a particular action (e.g., as indicated in a corresponding remediation model 303) for the identified type of threat (e.g., a particular scam model 301), such as outputting scam alert 401.

Detecting a potential threat may include, for example, computing on an ongoing process a level of risk, a threat score, etc. for a given communication, where such level of risk, threat score, etc. is based on comparing attributes of the communication to attributes indicated in one or more scam models 301. As discussed above, comparing such attributes may include identifying audio content of the communication, video content of the communication, location of devices or users engaged in the communication, a time of day associated with the communication, an identity of devices or users engaged in the communication, and/or any or all attributes of user and/or device model 107 and/or scam models 301. The level of risk, threat score, etc. may be based on, in some embodiments, a measure of similarity or affinity between user and/or device model 107 and one or more respective scam models 301. In some embodiments, a communication with a level of risk, threat score, etc. that exceeds a particular threshold may be considered as being associated with a potential threat, scam, or the like.

As discussed above, scam alert 401 may vary based on information specified in respective remediation models 303, such as a first type of scam alert 401 that includes an audible message (e.g., an audible warning of a potential scam, an indication that more information should be requested to verify identity of a caller, etc.), a second type of scam alert 401 that includes a pop-up notification, a third type of scam alert 401 that includes a text-based message alert, etc. ASEDS 101 may, for example, output scam alert 401 to user device 103 for which the potential threat has been identified, to a particular application server 201 that is in communication with user device 103, and/or to some other suitable device or system.

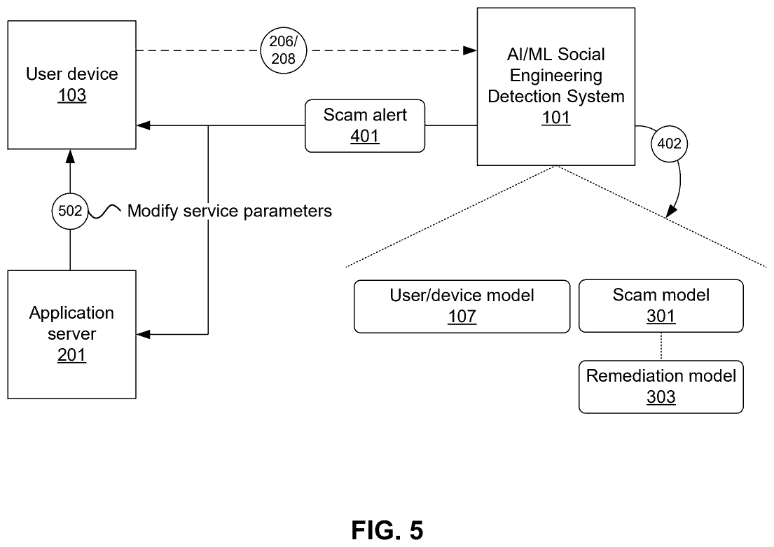

As shown in FIG. 5, for example, ASEDS 101 may output scam alert 401 (e.g., as generated based on a particular identified scam model 301 and an associated remediation model 303) to user device 103 and/or to application server 201 that is providing a service to user device 103. In one example, the service provided by application server 201 is a service with which the identified scam is associated. For example, application server 201 may be a voice call server that hosts, facilitates, etc. a voice call session during which spoken phrases are a factor based on which a potential threat is identified with respect to the voice call session. In another example, application server 201 may be a separate device or system (e.g., other than a device that is associated with a communication session for which a threat has been identified). Application server 201 may modify (at 502) parameters of a service provided to user device 103 (e.g., by application server 201) based on receiving the scam alert 401. For example, application server 201 may disconnect a call, may present a visual overlay on a GUI of user device 103, may reroute a call to a secure server, and/or may perform some other type of service modification based on receiving scam alert 401.

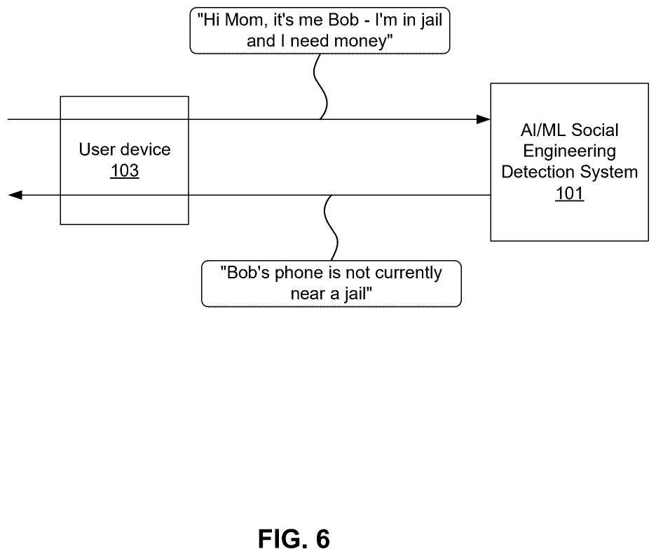

FIGS. 6-9 illustrate example scenarios in which ASEDS 101 may detect potential threats based on individual user and/or device information associated with a given user device 103 or user thereof (e.g., based on an associated user and/or device model 107, as discussed above). In the example of FIG. 6, a particular communication associated with user device 103 may include a phone call, in which the phrase “Hi Mom, it's me Bob—I'm in jail and I need money.” ASEDS 101 may evaluate attributes of the communication, such as the request for money as well as an included fact pattern of the communication (e.g., son or family member in jail), in determining that the communication is associated with a particular type of scam (e.g., a particular scam model 301). ASEDS 101 may further augment this detection with additional information associated with user device 103 or a user thereof (e.g., based on an associated user and/or device model 107) to determine factors such as whether the user has a son named Bob, whether the voice of the individual purporting to be Bob matches a previously identified voice sample for Bob, and/or other suitable factors. In this example, ASEDS 101 may further identify information such as a location of Bob's phone (e.g., in situations where Bob has granted consent for the location of Bob's phone to be shared with user device 103 and/or with ASEDS 101) does not match the location of a jail. Accordingly, ASEDS 101 may output a notification (e.g., an audible notification or some other suitable type of notification) to user device 103, indicating that Bob's phone is not currently located near a jail. This may provide the user of user device 103 with adequate information to protect themselves from any further attempts to effectuate a social engineering attack, or to further investigate with the person purporting to be Bob as to whether such person actually is Bob and whether Bob does actually need money to get out of jail. In either event, the user of user device 103 is provided with a powerful, AI/ML-based solution that helps the user make an informed decision of how to proceed.

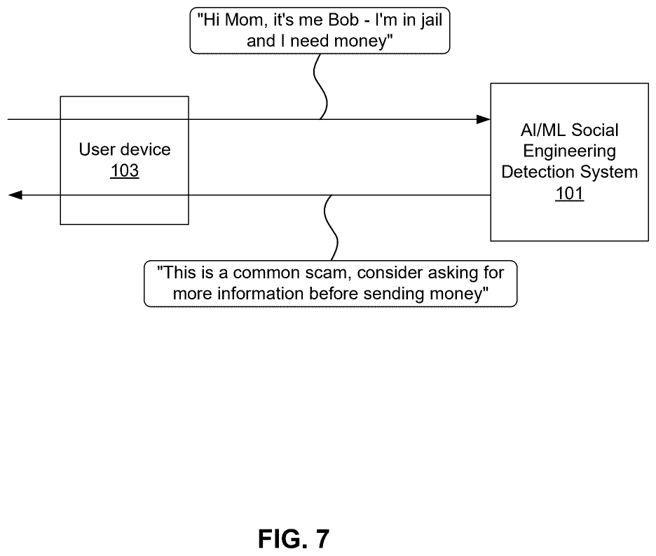

In the example of FIG. 7, ASEDS 101 may provide a different type of alert or response to user device 103 based on the above example request from the person purporting to be Bob, potentially in the presence of different factors. For example, in FIG. 7, assume that ASEDS 101 does not have location information associated with Bob's phone. In this example, ASEDS 101 may nevertheless identify (e.g., based on content of the call) that the content of the call is potentially a scam. ASEDS 101 may accordingly notify user device 103 of the potential scam, in order to provide the user with adequate information to proceed cautiously.

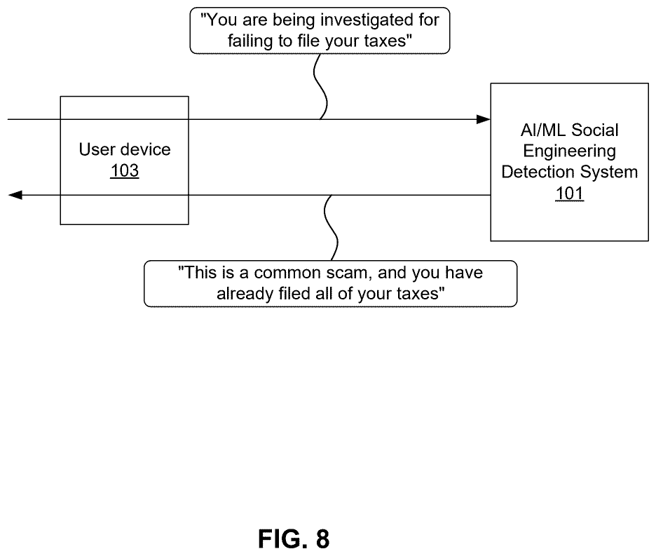

FIG. 8 illustrates another example in which a scam threatens a user with fines or penalties for failing to file taxes. As noted above, user and/or device model 107 may include information from sources such as governmental agencies, private databases, or the like. In this instance, user and/or device model 107 may indicate that a user of user device 103 has already filed their taxes, and the statement in the communication (“failing to file your taxes”) contains false information that is further associated with previously identified scams (e.g., is associated with a particular scam model 301). In other words, the presence of the phrase “failing to file your taxes” may indicate a threat pattern (e.g., a pattern, such as a set of words or phrases in this instance, that has been previously identified as being associated with a scam, a threat, etc.). For example, one or more models (e.g., cybersecurity models) may indicate that the presence of this phrase matches a particular threat pattern.

ASEDS 101 may accordingly notify (e.g., via an audible alert or some other suitable mode of communication) that the communication is likely to be a scam (and/or otherwise matches a threat pattern), and may further indicate a reasoning for determining the scam (e.g., that the communication indicates that the user's taxes have not been filed, while the user's taxes have in fact been filed).

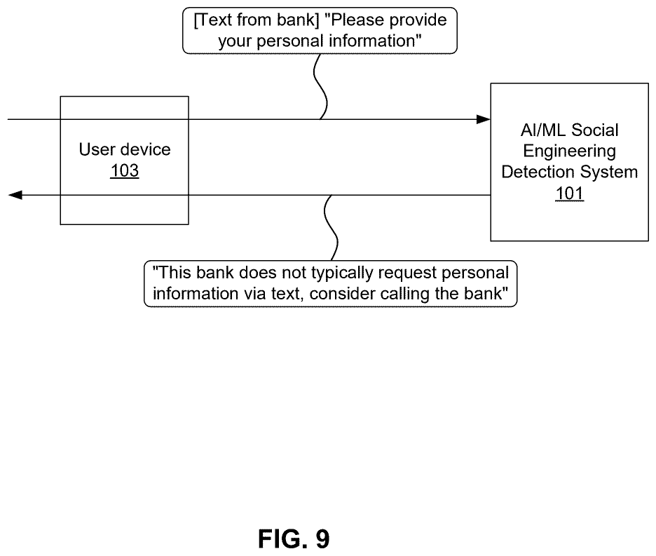

FIG. 9 illustrates an example in which a user device 103 indicates that a text message has been received from a bank, requesting personal information such as name, address, social security number, bank account number, password, etc. As another example, the text message may include a clickable link (e.g., a Uniform Resource Locator (URL)), which may link to a web page that may further exploit the user. ASEDS 101 may identify that banks (and/or this bank in particular) do not typically request personal information via text message and/or do not typically request such information via links sent in text messages. ASEDS 101 may accordingly alert the user of user device 103 that the bank does not typically request personal information via text message.

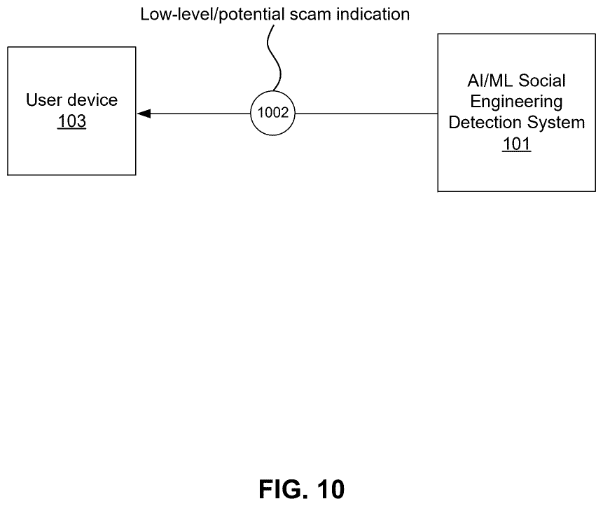

In some embodiments, different severities of threats or scams, and/or confidence levels or risk scores indicating that communications are scams or are potential threats, may be used to provide different types of alerts. For example, as shown in FIG. 10, a low-level or potential scam may be identified and provided (at 1002) to user device 103. The low-level or potential scam may be identified in a situation in which not enough information about a communication is available to positively determine whether the communication is associated with a threat or is not associated with a threat, and/or in which factors weigh in favor of both a scam determination as well as a non-scam determination.

In one example, the communication may include a voice call from a person purporting to be the Chief Executive Officer (CEO) of a company, and a user of user device 103 may be an employee of the company. In this example, the user may not know the CEO personally. However, the voice may match the voice of the CEO (e.g., as may be potentially identified based on publicly available voice samples). In this situation, certain factors indicate the likelihood of a scam, while other factors indicate the likelihood of a legitimate call. That is, in this situation, respective factors weigh potentially heavily both towards the likelihood of a scam as well as the likelihood of a legitimate communication (where such likelihood is further determined based on specific attributes of user device 103 or a user thereof, such as a determination that the user and the CEO are both employed by the same company). Accordingly, since factors weigh heavily in both directions, ASEDS 101 may indicate that further caution should be exercised or further verification should be obtained before proceeding.

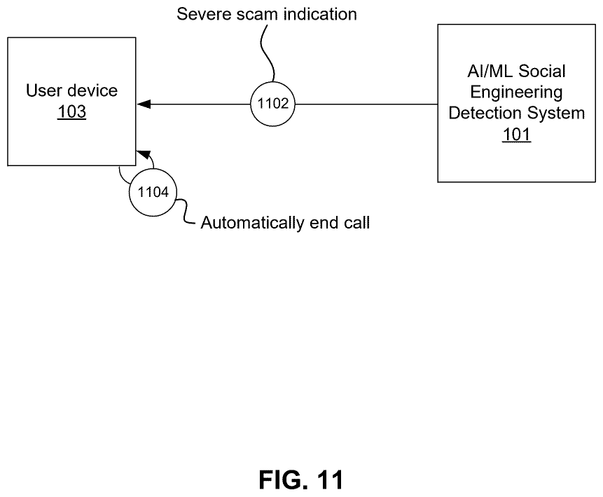

On the other hand, as shown in FIG. 11, a severe scam indication may be indicated (at 1102) when ASEDS 101 determines that a particular type of scam (e.g., a particular scam model 301) has been detected, and/or when the likelihood of a scam determination exceeds or greatly exceeds one or more severity or risk thresholds. Based on receiving a severe scam indication, user device 103 may perform actions such as automatically ending (at 1104) a call, blocking a contact or party that has been identified as being associated with a severe scam, etc.

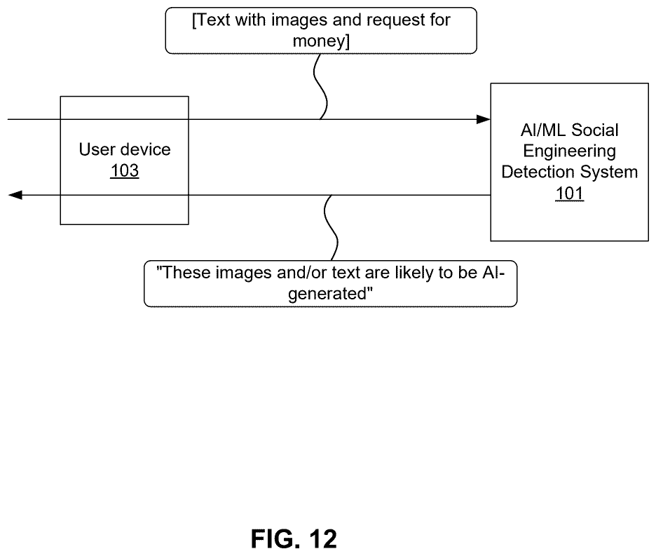

As another example, such as in FIG. 12, ASEDS 101 may receive information indicating that user device 103 has received a series of text messages and/or images from an individual. ASEDS 101 may further identify, based on content of the messages (e.g., provocative pictures, requests for money, etc.) and further based on one or more AI detection techniques, that the communications from the individual are likely to have been AI-generated and/or that such messages meet one or more patterns associated with one or more social engineering attacks (e.g., “catfishing” attacks). ASEDS 101 may indicate, to user device 103, that the images and/or text are likely to be AI-generated, and/or that the messages are associated with a social engineering attack sometimes referred to as catfishing.

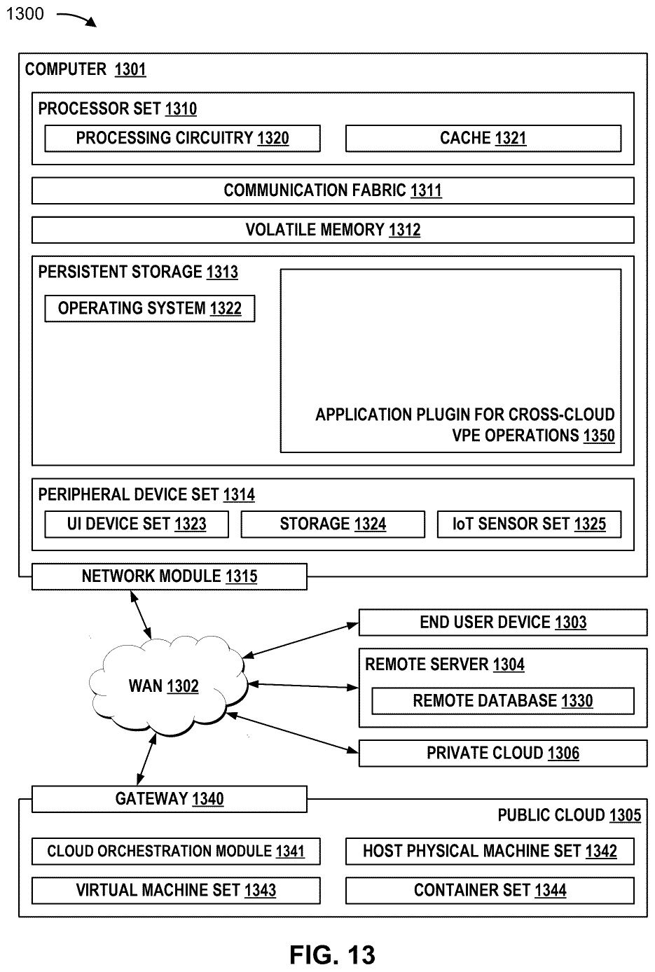

FIG. 13 is a diagram of an example computing environment 1300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as application plugin for cross-cloud virtual private endpoint (VPE) operations 1350. In addition to application plugin for cross-cloud VPE operations 1350, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and application plugin for cross-cloud VPE operations 1350, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

Computer 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

Processor set 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in application plugin for cross-cloud VPE operations 1350 in persistent storage 1313.

Communication fabric 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

Persistent storage 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in application plugin for cross-cloud VPE operations 1350 typically includes at least some of the computer code involved in performing the inventive methods.

Peripheral device set 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

Network module 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1303 is any computer system that is used and controlled by an end user (for example, a customer of an enterprise that operates computer 1301) and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

Remote server 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

Public cloud 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

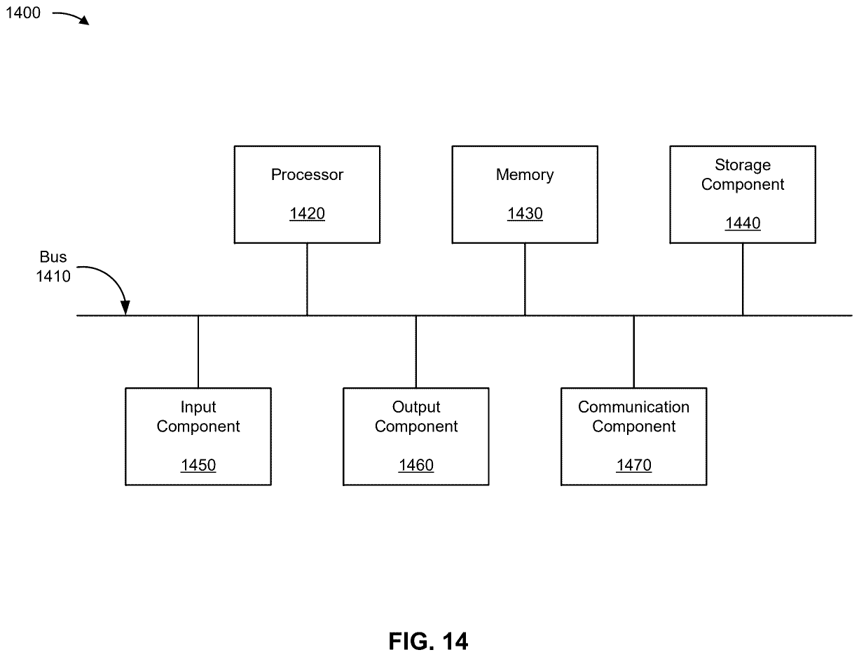

FIG. 14 is a diagram of example components of a device 1400, which may correspond to ASEDS 101, application server 201, user device 103, among other examples. In some implementations, the ASEDS 101, application server 201, and/or user device 103 may include one or more devices 1400 and/or one or more components of device 1400. As shown in FIG. 14, device 1400 may include a bus 1410, a processor 1420, a memory 1430, a storage component 1440, an input component 1450, an output component 1460, and a communication component 1470.

Bus 1410 includes a component that enables wired and/or wireless communication among the components of device 1400. Processor 1420 includes a central processing unit, a graphics processing unit, a microprocessor, a controller, a microcontroller, a digital signal processor, a field-programmable gate array, an application-specific integrated circuit, and/or another type of processing component. Processor 1420 is implemented in hardware, firmware, or a combination of hardware and software. In some implementations, processor 1420 includes one or more processors capable of being programmed to perform a function. Memory 1430 includes a random access memory, a read only memory, and/or another type of memory (e.g., a flash memory, a magnetic memory, and/or an optical memory).

Storage component 1440 stores information and/or software related to the operation of device 1400. For example, storage component 1440 may include a hard disk drive, a magnetic disk drive, an optical disk drive, a solid state disk drive, a compact disc, a digital versatile disc, and/or another type of non-transitory computer-readable medium. Input component 1450 enables device 1400 to receive input, such as user input and/or sensed inputs. For example, input component 1450 may include a touch screen, a keyboard, a keypad, a mouse, a button, a microphone, a switch, a sensor, a global positioning system component, an accelerometer, a gyroscope, and/or an actuator. Output component 1460 enables device 1400 to provide output, such as via a display, a speaker, and/or one or more light-emitting diodes. Communication component 1470 enables device 1400 to communicate with other devices, such as via a wired connection and/or a wireless connection. For example, communication component 1470 may include a receiver, a transmitter, a transceiver, a modem, a network interface card, and/or an antenna.

Device 1400 may perform one or more processes described herein. For example, a non-transitory computer-readable medium (e.g., memory 1430 and/or storage component 1440) may be a repository that stores a set of instructions (e.g., one or more instructions, code, software code, and/or program code) for execution by processor 1420. Processor 1420 may execute the set of instructions to perform one or more processes described herein. In some implementations, execution of the set of instructions, by one or more processors 1420, causes the one or more processors 1420 and/or the device 1400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 14 are provided as an example. Device 1400 may include additional components, fewer components, different components, or differently arranged components than those shown in FIG. 14. Additionally, or alternatively, a set of components (e.g., one or more components) of device 1400 may perform one or more functions described as being performed by another set of components of device 1400.

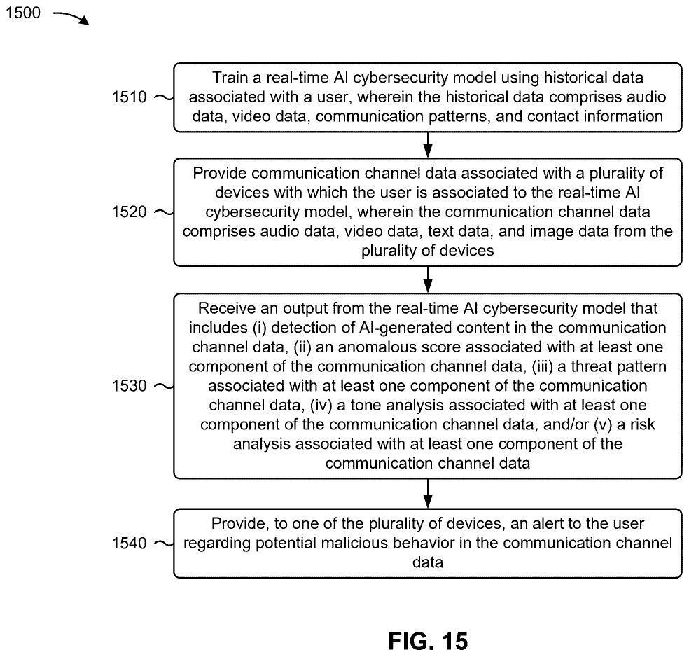

FIG. 15 is a flowchart of an example process 1500 associated with real-time AI/ML-based threat detection associated with one or more modes of communication. In some implementations, one or more process blocks of FIG. 15 may be performed by a computing device (e.g., ASEDS 101 and/or user device 103). In some implementations, one or more process blocks of FIG. 15 may be performed by another device or a group of devices separate from or including the computing device, such as an additional computing device, a network device, or a cloud-based device. Additionally, or alternatively, one or more process blocks of FIG. 15 may be performed by one or more components of device 1400, such as processor 1420, memory 1430, storage component 1440, input component 1450, output component 1460, and/or communication component 1470.

As shown in FIG. 15, process 1500 may include training a real-time AI cybersecurity model using historical data associated with a user, wherein the historical data comprises audio data, video data, communication patterns, and contact information (block 1510). For example, the computing device generate or refine one or more user and/or device models 107, as described above.

As further shown in FIG. 15, process 1500 may include providing communication channel data associated with a plurality of devices with which the user is associated to the real-time AI cybersecurity model, wherein the communication channel data comprises audio data, video data, text data, and image data from the plurality of devices (block 1520). For example, the computing device may receive, from user device 103, one or more application servers 201, and/or other suitable sources, communication channel information such as application traffic, voice traffic, video data, audio data, or the like, associated with ongoing communications associated with user device 103 and/or user devices 103 of a particular device group 105.

As further shown in FIG. 15, process 1500 may include receiving an output from the real-time AI cybersecurity model that includes (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, and/or (v) a risk analysis associated with at least one component of the communication channel data (block 1530). For example, ASEDS 101 may detect, based on user and/or device model 107 associated with the user, and/or further based on one or more scam models 301, the existence of a potential threat, such as a scam, a social engineering attack, or the like, as described above.

As additionally shown in FIG. 15, process 1500 may include providing, to one of the plurality of devices, an alert to the user regarding potential malicious behavior in the communication channel data (block 1540). For example, as discussed above, user device 103 may present a notification, such as a visual notification, an audible notification, etc. of the identified potential threat.

Process 1500 may include additional implementations, such as any single implementation or any combination of implementations described below and/or in connection with one or more other processes described elsewhere herein.

In a first implementation, the audio data includes one or more voice samples of a user of the user.

In a second implementation, alone or in combination with the first implementation, the audio data includes one or more voice samples of one or more other users with which the user has communicated via the plurality of devices.

In a third implementation, alone or in combination with one or more of the first and second implementations, the one or more voice samples of the one or more other users is a first set of voice samples, wherein the real-time AI cybersecurity model includes a second set of voice samples, wherein the tone analysis includes comparing the first set of voice samples to the second set of voice samples.

In a fourth implementation, alone or in combination with one or more of the first through third implementations, the threat pattern includes a set of words or phrases that have been previously determined as being associated with one or more scams.

In a fifth implementation, alone or in combination with one or more of the first through fourth implementations, process 1500 further includes obtaining consent, from the user, to provide the communication channel data associated with the plurality of devices, wherein providing the communication channel data is performed after obtaining consent from the user.

In a sixth implementation, alone or in combination with one or more of the first through fifth implementations, the risk analysis is further based on determining whether the communication channel data includes one or more users indicated in the contact information.

Although FIG. 15 shows example blocks of process 1500, in some implementations, process 1500 may include additional blocks, fewer blocks, different blocks, or differently arranged blocks than those depicted in FIG. 15. Additionally, or alternatively, two or more of the blocks of process 1500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
training a real-time AI cybersecurity model using historical data associated with a user, wherein the historical data comprises at least one of audio data, video data, text data, communication patterns, or contact information;
providing communication channel data associated with a plurality of devices with which the user is associated to the real-time AI cybersecurity model, wherein the communication channel data comprises audio data, video data, text data, and image data from the plurality of devices;
receiving an output from the real-time AI cybersecurity model that includes at least one of (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, or (v) a risk analysis associated with at least one component of the communication channel data; and
displaying, on one of the plurality of devices, an alert to the user regarding potential malicious behavior in the communication channel data.

2. The computer-implemented method of claim 1, wherein the audio data includes one or more voice samples of a user of the user.

3. The computer-implemented method of claim 1, wherein the audio data includes one or more voice samples of one or more other users with which the user has communicated via the plurality of devices.

4. The computer-implemented method of claim 3, wherein the one or more voice samples of the one or more other users is a first set of voice samples, wherein the real-time AI cybersecurity model includes a second set of voice samples, wherein the tone analysis includes comparing the first set of voice samples to the second set of voice samples.

5. The computer-implemented method of claim 1, wherein the threat pattern includes a set of words or phrases that are indicated in the real-time AI cybersecurity model as being associated with one or more scams.

6. The computer-implemented method of claim 1, further comprising:
obtaining consent, from the user, to provide the communication channel data associated with the plurality of devices, wherein providing the communication channel data is performed after obtaining consent from the user.

7. The computer-implemented method of claim 1, wherein the risk analysis is further based on determining whether the communication channel data includes one or more users indicated in the contact information.

8. A computer program product comprising:
one or more computer readable storage media, and program instructions collectively stored on the one or more computer readable storage media, the program instructions comprising:
program instructions to train a real-time AI cybersecurity model using historical data associated with a user, wherein the historical data comprises at least one of audio data, video data, text data, communication patterns, or contact information;
program instructions to provide communication channel data associated with a plurality of devices with which the user is associated to the real-time AI cybersecurity model, wherein the communication channel data comprises audio data, video data, text data, and image data from the plurality of devices;
program instructions to receive an output from the real-time AI cybersecurity model that includes at least one of (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, or (v) a risk analysis associated with at least one component of the communication channel data; and
program instructions to display, on one of the plurality of devices, an alert to the user regarding potential malicious behavior in the communication channel data.

9. The computer program product of claim 8, wherein the audio data includes one or more voice samples of a user of the user.

10. The computer program product of claim 8, wherein the audio data includes one or more voice samples of one or more other users with which the user has communicated via the plurality of devices.

11. The computer program product of claim 10, wherein the one or more voice samples of the one or more other users is a first set of voice samples, wherein the real-time AI cybersecurity model includes a second set of voice samples, wherein the tone analysis includes comparing the first set of voice samples to the second set of voice samples.

12. The computer program product of claim 8, wherein the threat pattern includes a set of words or phrases that have been previously determined as being associated with one or more scams.

13. The computer program product of claim 8, wherein the program instructions further comprise:
program instructions to obtain consent, from the user, to provide the communication channel data associated with the plurality of devices, wherein providing the communication channel data is performed after obtaining consent from the user.

14. The computer program product of claim 8, wherein the risk analysis is further based on determining whether the communication channel data includes one or more users indicated in the contact information.

15. A system, comprising:
one or more devices configured to:
train a real-time AI cybersecurity model using historical data associated with a user, wherein the historical data comprises at least one of audio data, video data, communication patterns, or contact information;
provide communication channel data associated with a plurality of devices with which the user is associated to the real-time AI cybersecurity model, wherein the communication channel data comprises audio data, video data, text data, and image data from the plurality of devices;
receive an output from the real-time AI cybersecurity model that includes at least one of (i) detection of AI-generated content in the communication channel data, (ii) an anomalous score associated with at least one component of the communication channel data, (iii) a threat pattern associated with at least one component of the communication channel data, (iv) a tone analysis associated with at least one component of the communication channel data, or (v) a risk analysis associated with at least one component of the communication channel data; and
display, on one of the plurality of devices, an alert to the user regarding potential malicious behavior in the communication channel data.

16. The system of claim 15, wherein the audio data includes one or more voice samples of a user of the user.

17. The system of claim 15, wherein the audio data includes one or more voice samples of one or more other users with which the user has communicated via the plurality of devices.

18. The system of claim 15, wherein the threat pattern includes a set of words or phrases that are indicated in the real-time AI cybersecurity model as being associated with one or more scams.

19. The system of claim 15, wherein the one or more devices are further configured to:
obtain consent, from the user, to provide the communication channel data associated with the plurality of devices, wherein providing the communication channel data is performed after obtaining consent from the user.

20. The system of claim 15, wherein the risk analysis is further based on determining whether the communication channel data includes one or more users indicated in the contact information.
